(19) United States
(12) Patent Application Publication
(10) Pub. No.: US 2005/0223834 A1
(43) Pub. Date: Oct. 13, 2005

(54) Inline automatic/manual shifter

(75) Inventor: Hiroyuki Otsuka, West Bloomfield, MI (US)

Correspondence Address: SHINJYU GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 10/811,914

(22) Filed: Mar. 30, 2004

(51) Int. Cl. B60K 20/00; F16H 59/02

(52) U.S. Cl. 74/473.18

(57) ABSTRACT

An inline automatic/manual shifter is provided with a shift lever that moves in a straight line path to select one of a shift position. Manual up-shift and down-shift switches are actuated by the shift lever while in the drive position to cause an upshift or a downshift of the automatic transmission. The shift position retaining mechanism includes a detent spring engages notches in a detent plate to hold the shift lever in one of the shift positions. A drive position notch has an up-shift switch ramp surface and a down-shift switch ramp surface with a center neutral drive location located between the up-shift and down-shift switch ramp surfaces. The up-shift and down-shift switch ramp surfaces are arranged such that the detent spring applies an urging force on the drive position notch to bias the detent spring and the shift lever to the center neutral drive location.

### BACKGROUND OF THE INVENTION

1. Field of the Invention

The present invention generally relates to an inline automatic/manual shifter. More specifically, the present invention relates to a shifter for an automatic transmission that includes a manual shift mode lying with the same shifting plane as the automatic shift mode.

2. Background Information

Typically, automotive vehicles having an automatic transmission have a shifter for selecting a gear position such as a park position “P”, a reverse position “R”, a neutral position “N” and a drive position “D”. However, more recently, vehicles with automatic transmissions have been developed that allow the driver to manually change the gear ratio of the transmission. A variety of shifting arrangements have been developed to accomplish both the automatic shift mode and the manual shift mode. One of the most common methods is to utilize a shifter with a shift lever that has an automatic shifting path and a manual shifting path. One example of such a shifting arrangement is disclosed in U.S. Pat. No. 6,080,083. In this shifting arrangement, the shift lever is moved in a lateral direction when a manual shift mode is desired. After the shift lever is moved in a lateral direction, the shift lever can be moved in either a forward or rearward direction for upshifting or downshifting the gear ratio of the transmission.

In view of the above, it will be apparent to those skilled in the art from this disclosure that there exists a need for an improved inline automatic/manual shifter. This invention addresses this need in the art as well as other needs, which will become apparent to those skilled in the art from this disclosure.

### SUMMARY OF THE INVENTION

It has been discovered that with most conventional shifting arrangement that requires two parallel shifting paths, the driver sometimes has a difficulty in moving the shift lever in a lateral direction to change from an automatic shift mode “D” to a manual shift mode “M”. Moreover, additional structure must often be provided for the shift lever to move in a lateral direction from the automatic shift mode “D” to the manual shift mode “M”. This additional structure can increase the cost for manufacturing the shifting arrangement. In addition, some conventional shifting arrangements require complex structures to change from the automatic shift mode “D” to the manual shift mode “M”. It has also been discovered that some conventional shifting arrangements move the automatic transmission cable (shifter force transmitting element) when the shift lever is moved during the manual shift mode “M”.

In view of the above, it is desirable to have the automatic shift mode and the manual shift mode lying in the same plane. Moreover, it is desirable to have the automatic transmission cable (shifter force transmitting element) for the automatic shift mode be disengaged when in the manual mode.

Accordingly, an inline automatic/manual shifter is provided that basically comprises a shift lever, a manual up-shift switch, a manual down-shift switch, a manual shift selector, and a shift position retaining mechanism. The shift lever is configured and arranged to selectively move in a straight line path to select one of a park position, a neutral position, a reverse position and a drive position. The manual up-shift switch is configured and arranged to be actuated by the shift lever while in the drive position to cause an upshift of the automatic transmission. The manual down-shift switch is configured and arranged to be actuated by the shift lever while in the drive position to cause a down-shift of the automatic transmission. The manual shift selector is configured and arranged to select a manual shift mode activating the manual up-shift switch and the manual down-shift switch. The shift position retaining mechanism includes a detent spring fixed to move with the shift lever and a shift position retaining element with a park position notch, a neutral position notch, a reverse position notch and a drive position notch. The detent spring is configured and arranged to selectively engage the notches of the shift position retaining element to selectively retain the shift lever in one of the park position, the neutral position, the reverse position and the drive position. The drive position notch is configured and arranged to form an up-shift switch ramp surface and a down-shift switch ramp surface with a center neutral drive location located between the up-shift and down-shift switch ramp surfaces. The up-shift and down-shift switch ramp surfaces are configured and arranged such that the detent spring applies an urging force on the drive position notch to bias the detent spring to the center neutral drive location. The up-shift and down-shift switch ramp surfaces are further configured and arranged such that the manual up-shift switch is operated when the detent spring is moved along the up-shift switch ramp surface and the manual down-shift switch is operated when the detent spring is moved along the down-shift switch ramp surface.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic diagram of an inline automatic/manual shifter for an automatic transmission that can be manually shifted in accordance with the present invention;

FIG. 2 is a simplified left side elevational view with the shift lever located in the park position P such that the shifter movement transmitting element is operatively coupled between the shift lever and the automatic transmission, and with selected portions of the inline automatic/manual shifter removed for purposes of illustration;

FIG. 3 is a simplified left side elevational view with the shift lever located in the reverse position R such that the shifter movement transmitting element is operatively coupled between the shift lever and the automatic transmission, and with selected portions of the inline automatic/manual shifter removed for purposes of illustration;

FIG. 4 is a simplified left side elevational view of the shift lever located in the neutral position N such that the shifter movement transmitting element is operatively coupled between the shift lever and the automatic transmission, and with selected portions of the inline automatic/manual shifter removed for purposes of illustration;

FIG. 5 is a simplified left side elevational view of the inline automatic/manual shifter with the shift lever located in the drive position D such that the shifter movement transmitting element is disengaged from the shift lever, and with selected portions of the inline automatic/manual shifter removed for purposes of illustration;

FIG. 6 is an enlarged partial diagrammatic illustration of the inline automatic/manual shifter with the shift lever being temporarily held in the manual up-shift position (M+ position) and with selected portions of the inline automatic/manual shifter removed for purposes of illustration;

FIG. 7 is an enlarged partial diagrammatic illustration of the inline automatic/manual shifter with the shift lever being temporarily held in the manual down-shift position (M− position) and with selected portions of the inline automatic/manual shifter removed for purposes of illustration;

FIG. 8 is an enlarged partial diagrammatic illustration of the shift position retaining mechanism utilized in the inline automatic/manual shifter of the present invention;

FIG. 9 is a partial, enlarged side elevational view of the automatic transmission shift plate that is utilized to control the movement of the shift lever in accordance with the present invention;

FIG. 10 is a simplified cross-sectional view of the inline automatic/manual shifter in the park position P accordance with the present invention as seen along section line 10-10 of FIG. 2;

FIG. 11 is a simplified cross-sectional view of the inline automatic/manual shifter in the drive position D accordance with the present invention as seen along section line 11-11 of FIG. 5;

FIG. 12 is another simplified cross-sectional view of the inline automatic/manual shifter, similar to FIG. 11, as seen along section line 12-12 of FIG. 4, but with the shift button partially depressed to move the shift lever to the neutral position N in accordance with the present invention;

FIG. 13 is another simplified cross-sectional view of the inline automatic/manual shifter, similar to FIG. 11, as seen along section line 13-13 of FIG. 3, but with the shift button fully depressed to move the shift lever to either the reverse position R or the park position P in accordance with the present invention;

FIG. 14 is a simplified right side perspective view of the inline automatic/manual shifter with the shift lever in the park position P such that the shifter movement transmitting element is operatively coupled between the shift lever and the automatic transmission, and with selected portions removed for purposes of illustration;

FIG. 15 is a simplified right side perspective view of the inline automatic/manual shifter with the shift lever in the drive position D such that the shifter movement transmitting element is disengaged from the shift lever, and with selected portions removed for purposes of illustration;

FIG. 16 is a simplified left side perspective view of the inline automatic/manual shifter with the shift lever in the drive position D such that the shifter movement transmitting element is disengaged from the shift lever, and with selected portions removed for purposes of illustration; and

FIG. 17 is a simplified partially exploded right side perspective view of the inline automatic/manual shifter in accordance with the present invention with selected portions removed for purposes of illustration.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

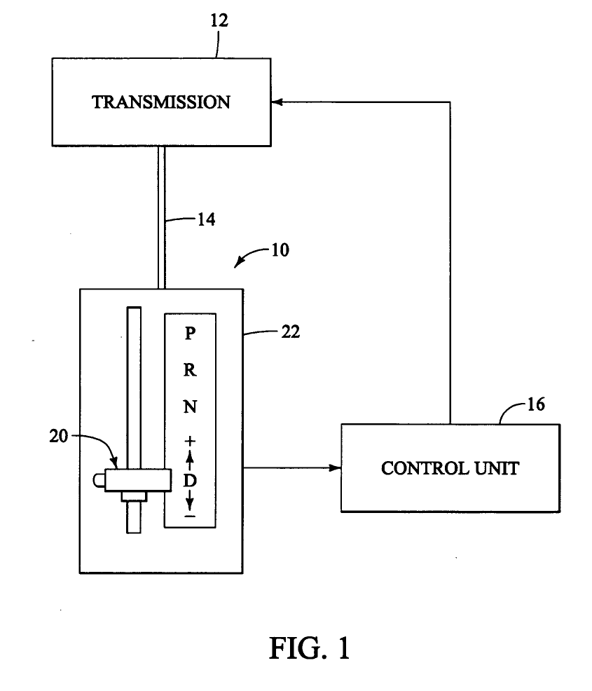

Referring initially to FIG. 1, an inline automatic/manual shifter 10 is illustrated in accordance with a preferred embodiment of the present invention. Basically, the inline automatic/manual shifter 10 is mechanically coupled to an automatic transmission 12 by a shifter movement transmitting element 14 such as an automatic transmission cable and/or linkage assembly. Also, the inline automatic/manual shifter 10 is electrically coupled to a control unit 16 for manually changing the gear ratio of the automatic transmission 12. The control unit 16 preferably includes a microprocessor with an automatic/manual control program that controls the automatic transmission 12 for changing the gear ratio of the automatic transmission 12 during both an automatic shift mode and a manual shift mode. The control unit 16 preferably includes other conventional components such as an input interface, an output interface and storage devices such as read-only memory (ROM), and random-access memory (RAM). The specifics of the control unit 16 and the automatic transmission 12 are not necessary to understand the present invention. Rather, any automatic transmission and any control unit that includes both an automatic shift mode and a manual shift mode can be utilized with the present invention.

Basically, the inline automatic/manual shifter 10 includes a shift lever 20 that is movable mounted to a housing 22 for movement along a single straight line path to select one of a park position P, a reverse position R, a neutral position N and a drive position D. Of course, additional gear positions can be utilized as needed and/or desired. When the shift lever 20 is located in the drive position D, the automatic transmission 12 is automatically shifted by the control unit 16 in accordance with various operating conditions. Also, when the shift lever 20 is located in the drive position D, the shift lever 20 can also be moved forwardly and rearwardly to manually upshift or downshift the automatic transmission 12 upon selecting a manual shift mode as discussed below.

In order to carry out both the automatic shift mode and the manual shift mode in a single straight line path, the inline automatic/manual shifter 10 is further provided with an automatic transmission cable lever 24, a manual up-shift switch 26, a manual down-shift switch 28, a shifter locking mechanism 30, and a shift position retaining mechanism 32. As explained later in more detail, the automatic transmission cable lever 24 is selectively coupled to the shift lever 20 to move therewith when the shift lever 20 is in any position other than the drive position D. When the shift lever 20 is the drive position D, the automatic transmission cable lever 24 is released from the shift lever 20 so that the automatic transmission cable lever 24 no longer moves with the shift lever 20. In other words, the shift lever 20 can move through a predetermined range of movement to engage the manual up-shift and down-shift switches 26 and 28 without moving the automatic transmission cable lever 24 when shift lever 20 is the drive position D.

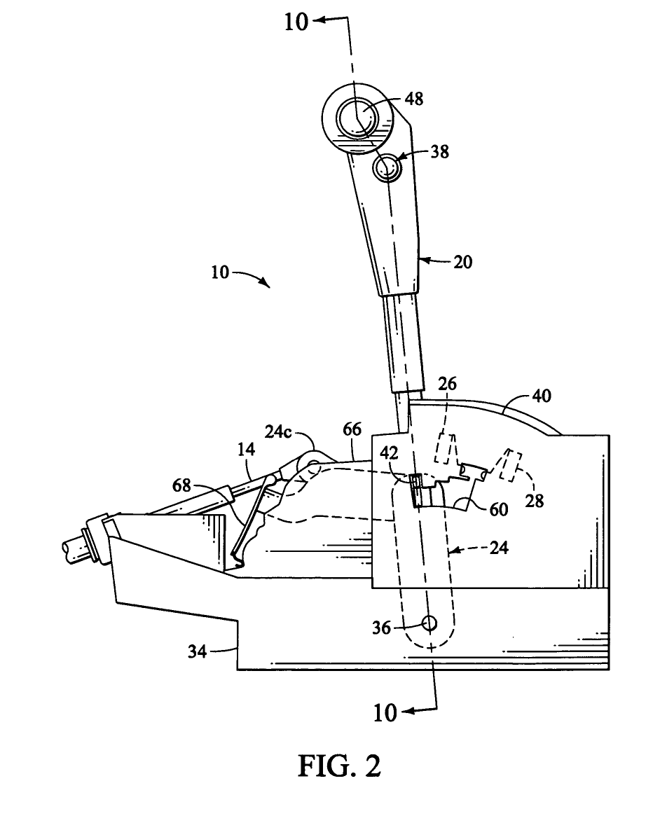

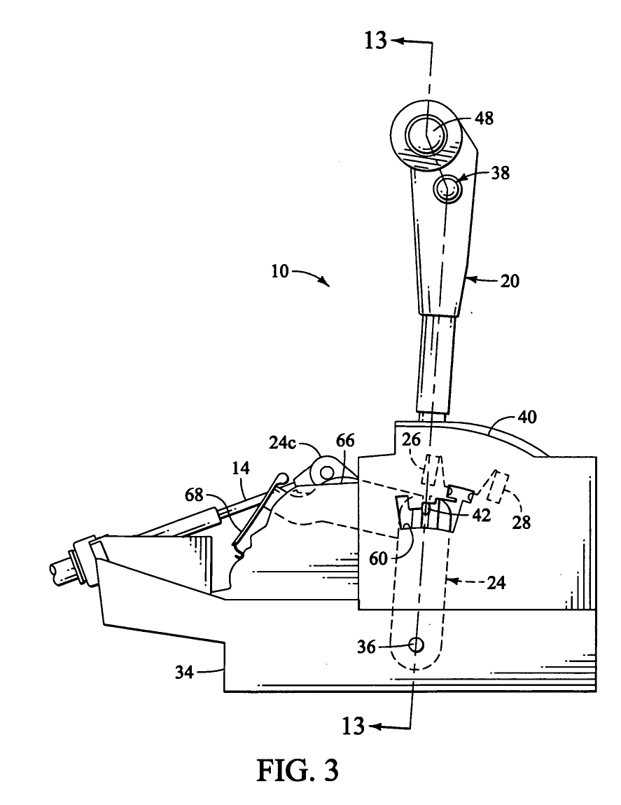

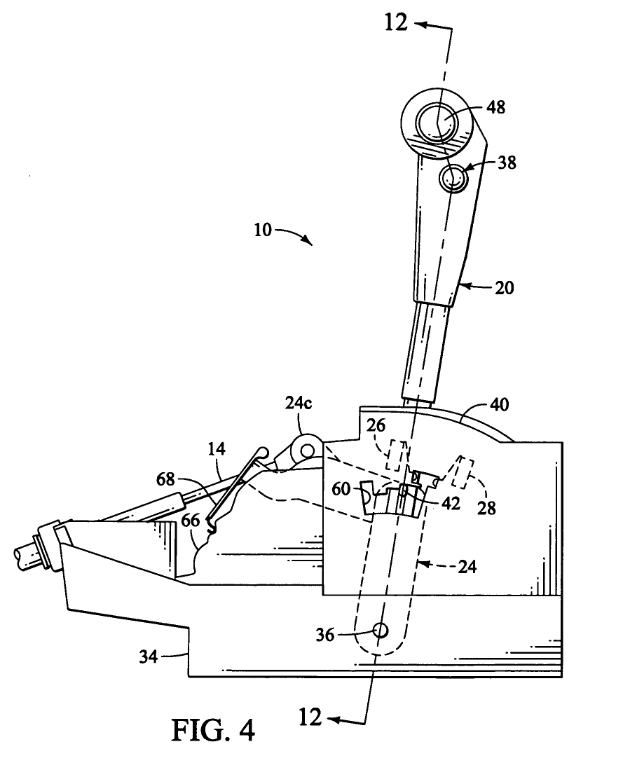

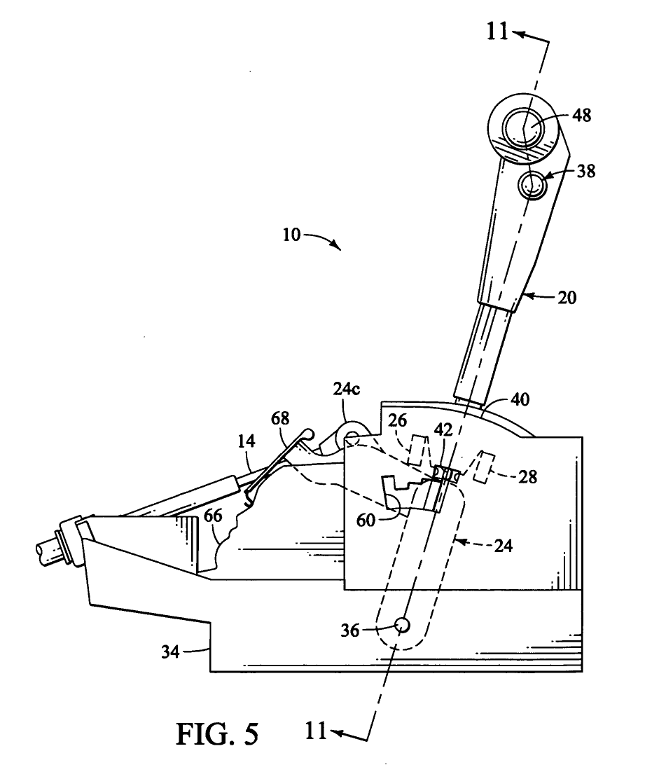

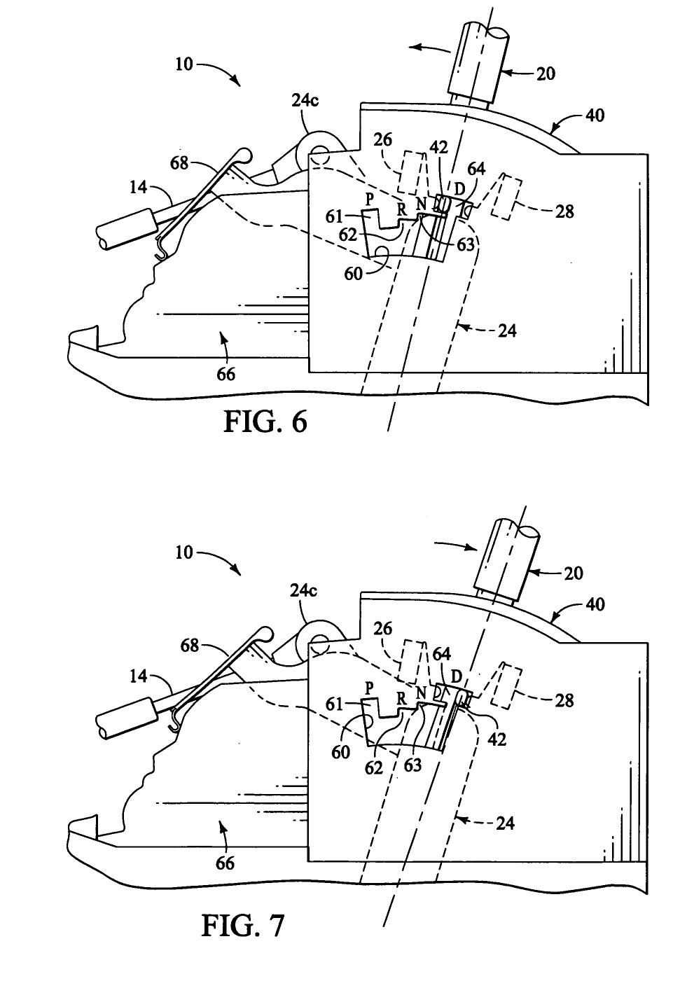

Referring to FIGS. 2-9, the shifter locking mechanism 30 and the shift position retaining mechanism 32 cooperate together to control the movement of the shift lever 20 between the park position P, the reverse position R, the neutral position N and the drive position D, as explained later in more detail. The park position P is illustrated in FIG. 2. The reverse position R is illustrated in FIG. 3. The neutral position N is illustrated in FIG. 4. The drive position D is illustrated in FIG. 5. As seen in FIGS. 6-9, the shift lever 20 can be moved forwardly and rearwardly to manually upshift and downshift the automatic transmission 12, respectively, upon selecting a manual shift mode as discussed below.

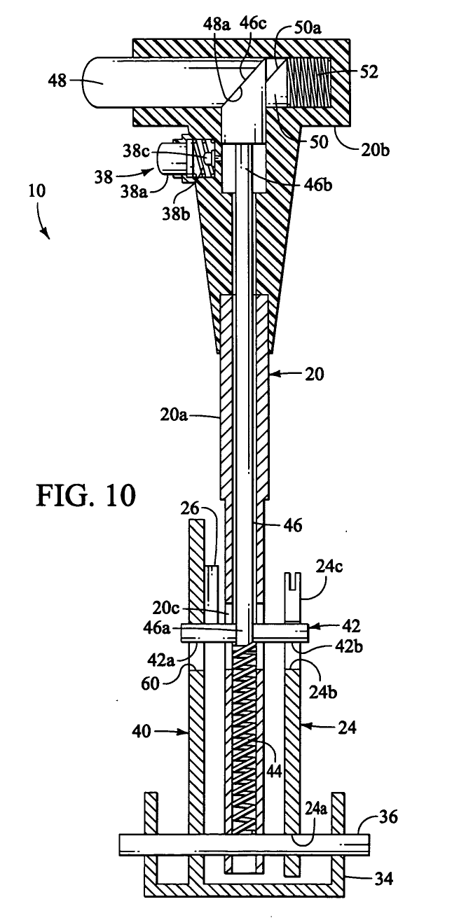

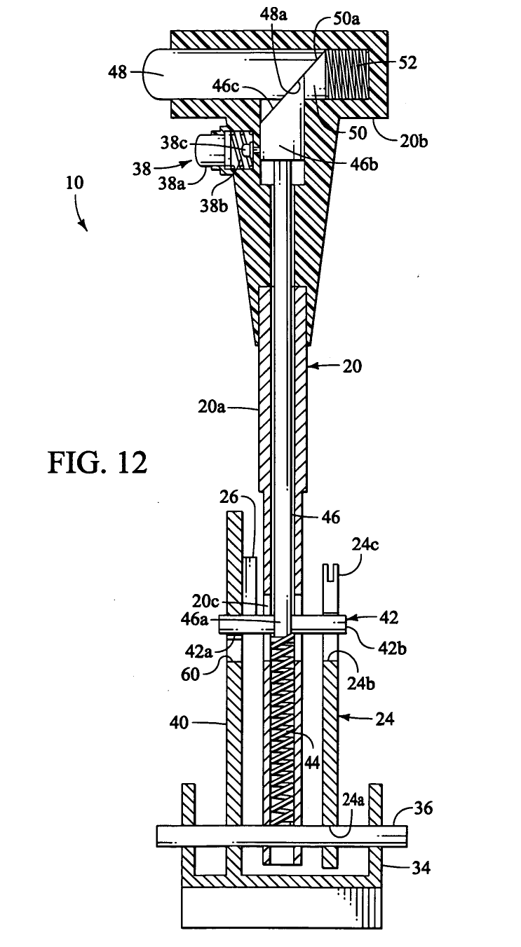

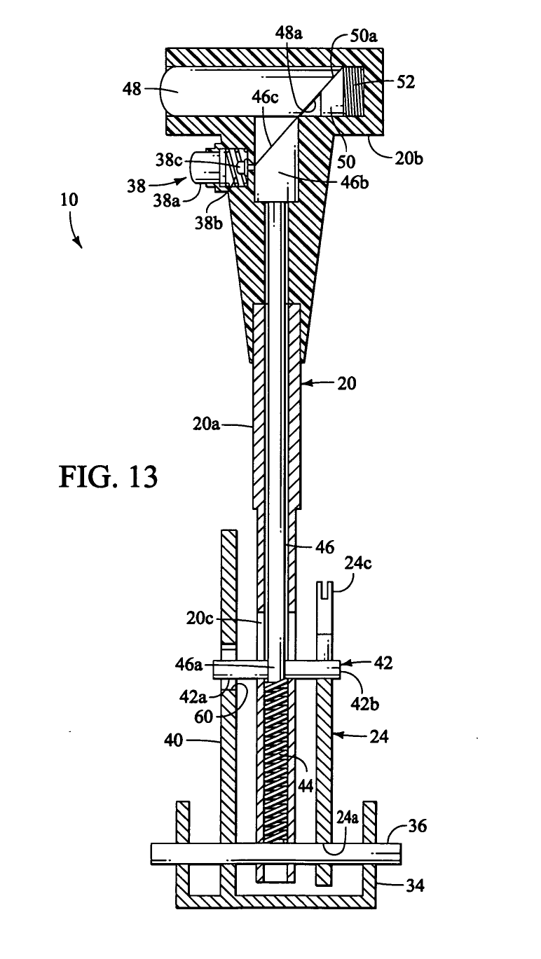

Referring to FIGS. 10-13, the shift lever 20 includes a tubular shaft portion 20a and a handle portion 20b mounted on the upper end of the tubular shaft portion 20a. The lower end of the shaft portion 20a is pivotally coupled to a base portion 34 of the housing 22 via a pivot pin 36. Thus, the shift lever 20 pivots in a single plane that defines the shift path of the shift lever 20. The shift lever 20 is normally held in one of the positions P, R, N and D by the shifter locking mechanism 30 and the shift position retaining mechanism 32. The shift lever 20 includes a manual shift selector or button 38 that is mounted on the handle portion 20b of the shifter 20. The manual shift selector 38 is configured and arranged to select a manual shift mode that actuates the manual up-shift switch 26 and the manual down-shift switch 28 when the shift lever 20 is located in the drive position D. In other words, when the when the shift lever 20 is located in the drive position D and the manual shift selector 38 has been depressed, the shift lever 20 can be moved forwardly to a manual up-shift position M+ to manually upshift the automatic transmission 12 or moved rearwardly to a manual down-shift position M− to manually downshift the automatic transmission 12.

Preferably, the manual shift selector 38 includes a button 38a that is biased outwardly by a spring 38b with an electrical switch 38c that is arranged to be actuated upon pushing the manual shift selector 38 inwardly. In particular, the switch 38c is arranged such that the electrical circuit is completed for sending an electrical signal to the control unit 16 such that the manual up-shift switch 26 and the manual down-shift switch 28 are activated such that the automatic transmission 12 can be manually shifted. In other words, the switch 38c of the manual shift selector 38 permits a vehicle driver to selectively switch between the automatic shift mode and the manual shift mode. Preferably a light or some other type of indicating indicia (not shown) is provide to indicate when the manual shift mode has been selected.

When the driver places the shift lever 20 in the drive position D and the manual shift selector 38 has been depressed, the shift lever 20, the automatic transmission 12 enters the manual shift mode. In this manual shift mode, when the driver moves the shift lever 20 in the upshift direction, the automatic transmission 12 shifts up to the next higher gear. When the driver moves the shift lever 20 in the downshift direction, the automatic transmission 12 shifts down to the next lower gear.

The shifter locking mechanism 30 includes an automatic transmission shift plate 40, a detent pin 42, a main spring 44, a connecting rod 46, a control button or selector 48, a control block 50 and a second spring 52. The shifter locking mechanism 30 is preferably a two-stage locking mechanism. Specifically, the control button 48 is pushed partially in order for the shift lever 20 to shift between the neutral position N and the drive position D. However, the control button 48 must be fully depressed in order for the shift lever 20 to move between the park position P and the reverse position R. Accordingly, the control button 48 is designed such that it can be easily pushed to the halfway position utilizing a small amount of pressing force (light effort), while a larger pushing force (higher effort) is required to fully depress the control button 48.

Inward movement of the control button 48 moves the detent pin 42 in a downward direction relative to the shaft portion 20a of the shift lever 20. In particular, the detent pin 42 is located in a pair of vertical slots 20c of the shaft portion 20a of the shift lever 20 so that the detent pin 42 is restrained to move only in the longitudinal direction of the shaft portion 20a of the shift lever 20. The connecting rod 46 is located within a center bore of the shaft portion 20a of the shift lever 20 for movement along the longitudinal axis of the shaft portion 20a of the shift lever 20. The connecting rod 46 has a lower end 46a that is fixedly coupled to the detent pin 42. The upper end 46b is located in the handle portion 20b of the shift lever 20. The upper end 46b of the connecting rod 46 has a slanted surface 46c that is engaged by the control button 48 for moving the connecting rod 46 and the detent pin 42 downwardly against the upward urging force of the main spring 44. More specifically, the control button 48 is slideably mounted within a bore of the handle portion 20b of the shift lever 20 for reciprocating movement. The inner end of the control button 48 has an inclined surface 48a that contacts the inclined surface 46c of the connecting rod 46. When the control button 48 is pushed inwardly, the inclined surface 48a slides along the inclined surface 46c of the connecting rod 46 such that the connecting rod 46 is pushed downwardly against the urging force of the spring 44. Thus, this downward movement of the connecting rod 46 moves the detent pin 42 downwardly. Once the control button 48 is moved to the halfway position, the connecting rod 46 is moved approximately half of its range of motion. At this point, the inclined surface 48a contacts an inclined surface 50a of the control block 50. Accordingly, further inward movement of the control button 48 causes the connecting rod 46 to continue to move downwardly as well as move the control block 50 against the urging force of the spring 52. Since the control button 48 is now moving both the connecting rod 46 and the control block 50, the effort to depress the control button 48 increases. Accordingly, when the control button 48 is moved to the halfway position, the detent pin 42 moves relative to the automatic transmission shift plate 40 so that the shift lever 20 can now be shifted from the drive position D to the neutral position N. However, the control button 48 must be fully depressed in order for the shift lever 20 to be shifted from the drive position D to the park position P or the reverse position R.

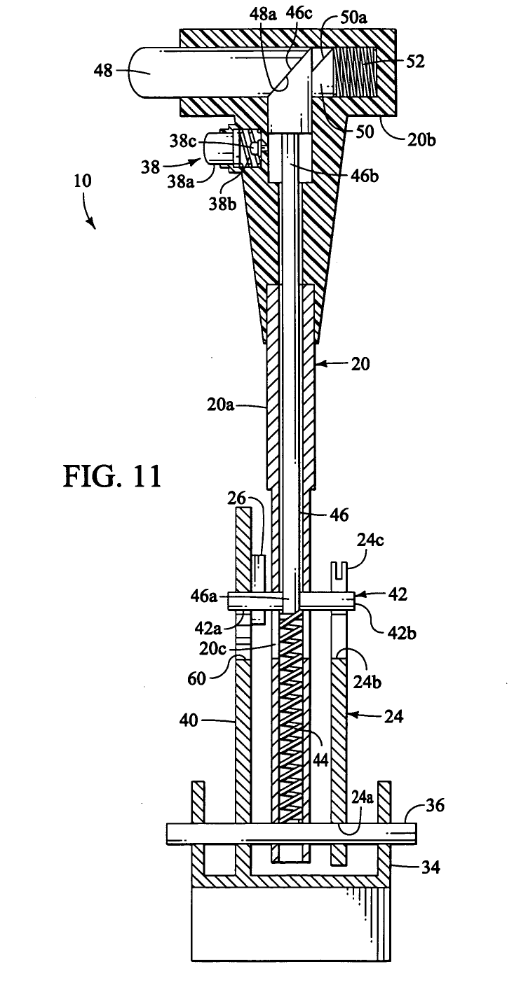

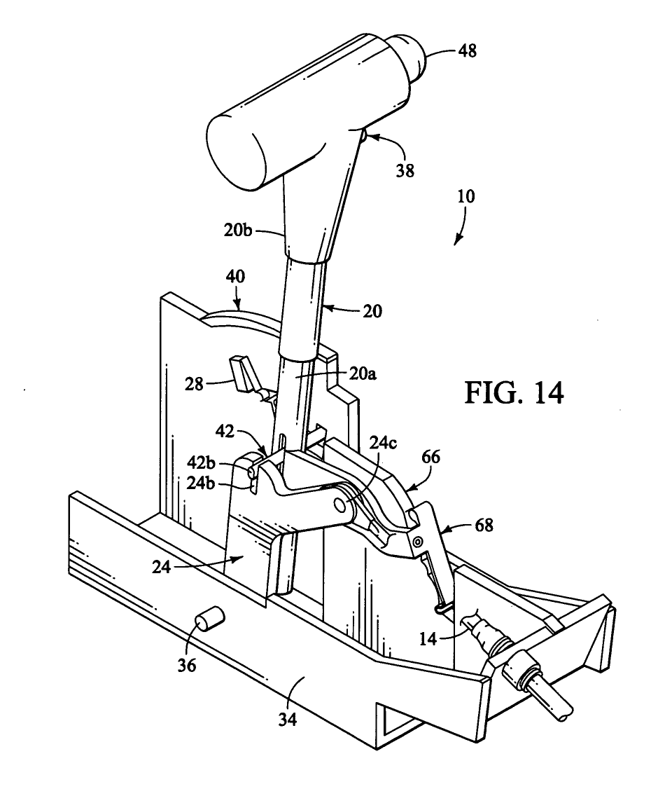

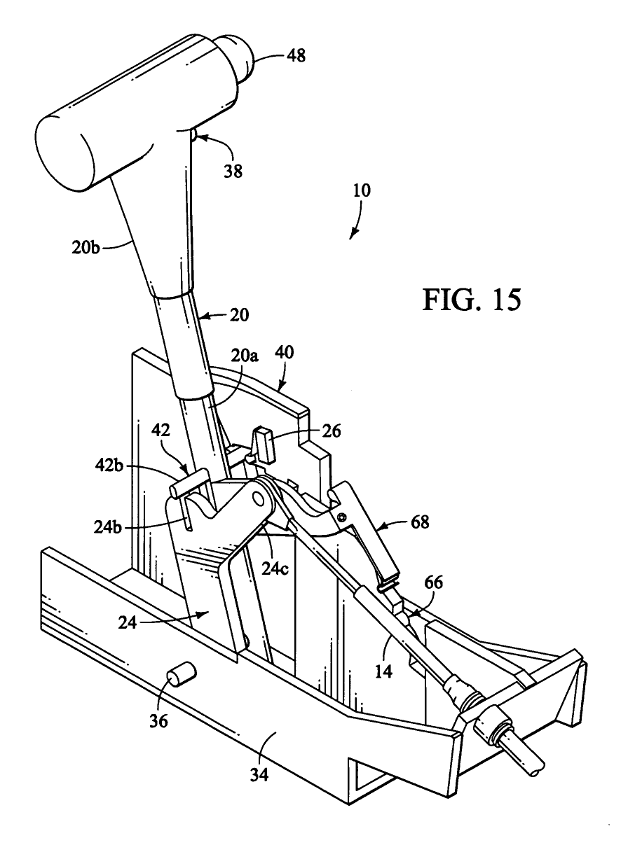

Referring now to FIGS. 10-15, the detent pin 42 has a first end 42a that is engaged with the shift plate 40 and a second end 42b that selectively engages the automatic transmission cable lever 24. When the detent pin 42 is in its uppermost position (FIGS. 11 and 15), the second end 42b of the detent pin 42 is disengaged from the automatic transmission cable lever 24 as explained below. This situation occurs only when the shift lever 20 is located in the drive position D. In all other positions, the second end 42b of the detent pin 42 is engaged with the automatic transmission cable lever 24 (FIGS. 10 and 12-14).

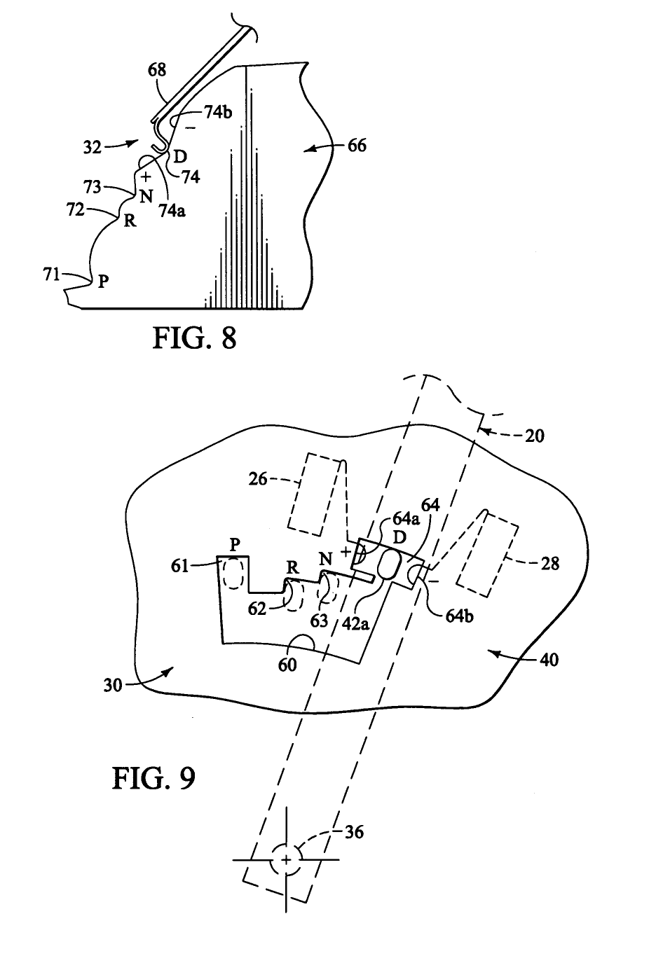

As seen in FIGS. 10-13, the shift plate 40 is a stationary member that is fixed to the base member 34. In the illustrated embodiment, the shift plate 40 is integrally formed with the base member 34. However, it will be apparent to those skilled in the art form this disclosure that the shift plate 40 can be formed as a separate member from the base member 34. In any event, the shift plate 40 has a shift gate opening 60 for engaging the first end 42a of the detent pin 42. Accordingly, movement of the shift lever 20 is restricted by the first end 42a of the detent pin 42 engaging the shift gate opening 60. As seen in FIG. 8, the shift gate opening 60 has a contoured surface that includes a plurality of abutments and/or slots for defining the various shift positions. In particular, the shift plate 40 has a slot 61 defining the park position P, an abutment 62 defining the reverse position R, an abutment 63 defining the neutral position N and a slot 64 defining the range of movement permitted while in the drive position D. The slot 64 thus has a forward abutment 64a limiting forward movement of the shift lever 20 while in the drive position D and a rear abutment 64b limiting rearward movement of the shift lever 20 while in the drive position D.

As seen in FIG. 9, the shift position retaining mechanism 32 basically includes a detent plate 66 and a detent spring 68. The detent plate 66 is a stationary member that is fixed to the base member 34, while the detent spring 68 is fixed to the shaft portion 20a of the shift lever 20 for movement therewith. In the illustrated embodiment, the detent plate 66 is integrally formed with the base member 34. However, it will be apparent to those skilled in the art form this disclosure that the detent plate 66 can be formed as a separate member from the base member 34. In any event, the detent plate 66 has a front surface with a plurality of undulations forming a park position notch 71, a reverse position notch 72, a neutral position notch 73 and a drive position notch 74. These notches 71-74 are configured and arranged to be selectively engaged by the detent spring 68 when the shift lever 20 is moved along the shift path. Accordingly, when the shift lever 20 is in the park position P, the detent spring 68 engages the park notch 71 and the detent pin 42 is located in the slot 61 of the shift plate 40. Similarly, when the shift lever 20 is moved to the drive position D, the detent spring 68 engages the drive position notch 74 and the detent pin 42 engages the drive slot 64 of the shift gate opening 60.

The drive position notch 74 of the detent plate 66 is preferably configured and arranged to form an up-shift switch ramp surface 74a and a down-shift switch ramp surface 74b with a center neutral drive location formed by the meeting point between the up-shift and down-shift switch ramp surfaces 74a and 74b. When the shift lever 20 is in the drive position D, the detent pin 42 is free to move within the drive slot 64 of the shift plate 40 such that the shift lever 20 can move along a predetermined manual shift range. the detent spring 68 rides up the up-shift switch ramp surface 74a when the shift lever 20 is moved forwardly from the center neutral drive location of the drive position D, and rides up the down-shift switch ramp surface 74b when the shift lever 20 is moved rearwardly from the center neutral drive location of the drive position D. The spring 68 is a relatively stiff spring that has a sufficient resiliency such that the shift lever 20 automatically move back to the center location of the drive position D, upon releasing the shift lever when the detent spring is located on either one of the up-shift and down-shift switch ramp surfaces 74a and 74b.

As seen in FIG. 6, when the shift lever 20 is moved forwardly from the center neutral drive location of the drive position D, the detent pin 42 moves forward to engage the manual up-shift switch 26 to cause an upshift of the automatic transmission 12. The range of motion of the shift lever 20 is limited by the detent pin 42 contacting the up-shift abutment 64a (FIG. 9). When the shift lever 20 is moved to the manual up-shift position, the detent spring 68 rides up the up-shift switch ramp surface 74a. When the shift lever 20 is in the manual up-shift position, the detent spring 68 applies an urging force against the up-shift switch ramp surface 74a of the drive position notch 74 to bias the detent spring 68 to the central neutral location of the drive position notch 74. Accordingly, this urging force of the detent spring 68 on the detent plate 66 causes the shift lever 20 to automatically move back to the center location of the drive position D. In this way, the driver can easily upshift the automatic transmission 12 by merely moving the shift lever 20 forwardly along the single straight line shift path of the shift lever 20.

Likewise, as seen in FIG. 7, when the shift lever 20 is pivoted rearwardly to the down-shift position, the detent pin 42 engages the manual down-shift switch 28 to cause a down-shift of the automatic transmission 12. Movement of the shift lever 20 is limited by the first end 34a of the detent pin contacting the down-shift abutment 64b (FIG. 9) of the shift plate 40. When the shift lever 20 is moved to the down-shift position, the detent spring 68 rides up the down-shift switch ramp surface 74b. Thus, the detent spring 68 applies an urging force on the drive position notch 74 of the detent plate 66 to bias the shift lever 20 to the center neutral drive location of the drive position notch 74. In other words, the detent spring 68 moves back to the central neutral location of the drive position notch 74 such that the shift lever 20 is automatically returned to the center location of the drive position notch 74. In this way, the driver can easily down-shift the automatic transmission 12 by merely moving the shift lever 20 rearwardly along the single straight line shift path of the shift lever 20.

The manual up-shift switch 26 and the manual down-shift switch 28 are preferably not energized unless the shift lever 28 is in the drive position and the manual shift selector 38 has been depressed. In particular, when the shift lever 20 is in any gear position other than the drive position, the detent pin 42 is held in a lower position out of the path of the manual up-shift switch 26 and the manual down-shift switch 28. In other words, the manual up-shift switch 26 and the manual down-shift switch 28 are not engaged by the detent pin 42 when the shift lever 20 is shifted between the various shift positions.

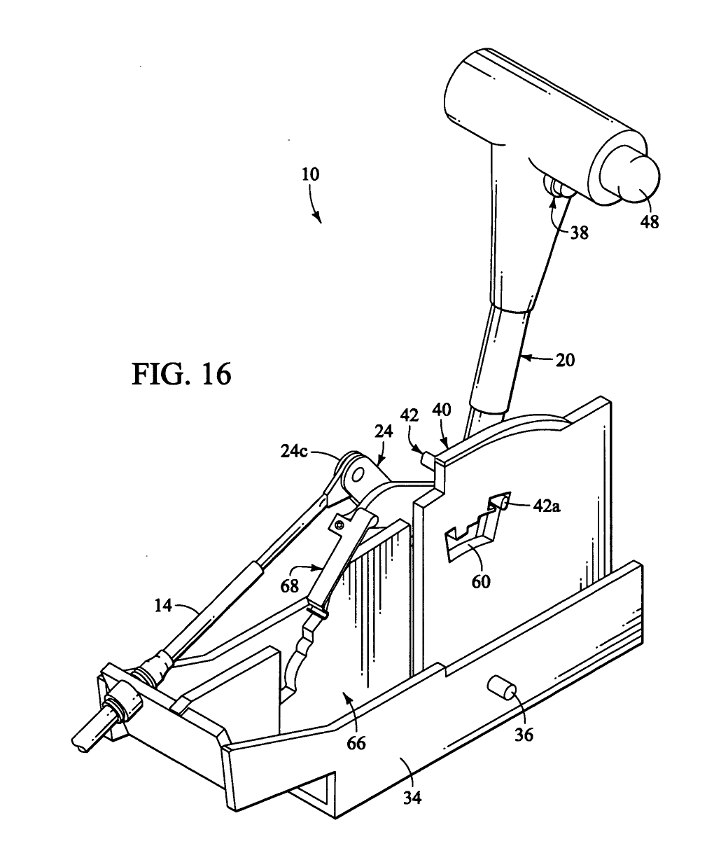

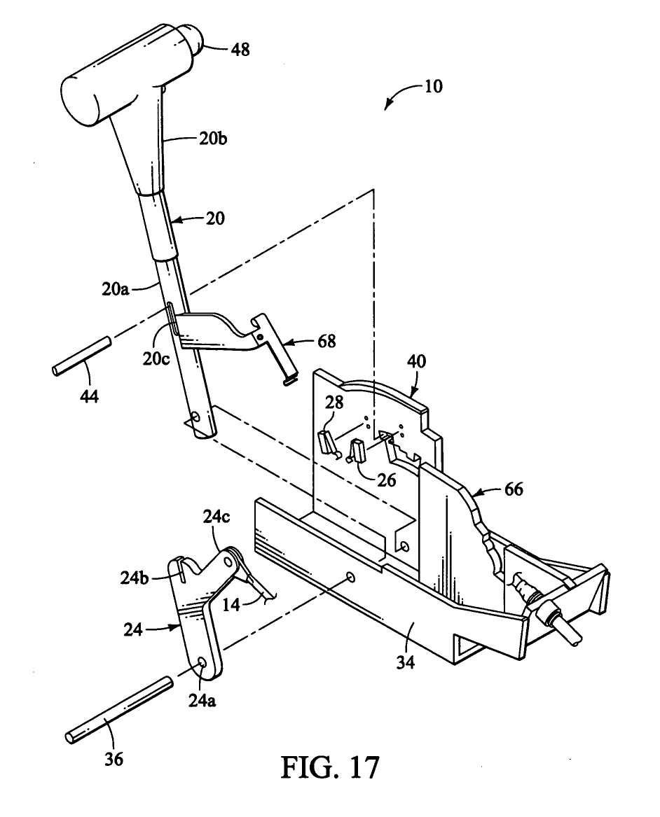

Referring to FIGS. 10-17, the automatic transmission cable lever 24 is pivotally coupled to the base portion 34 of the housing 22 via the pivot pin 36. Preferably, the shift lever 20 and the automatic transmission cable lever 24 both pivot about the same axis. The automatic transmission cable lever 24 is a plate like member that includes a lower pivot hole 24a, a detent pin engagement slot 24b and an automatic transmission connection part 24c.

In any position other then the drive position D, the automatic transmission cable lever 24 is locked to the shift lever 20 to move therewith. When the shift lever 20 is in the drive position D, the automatic transmission cable lever 24 is unlocked from the shift lever 20 so that the shift lever can move independently of the automatic transmission cable lever 24. Thus, the shifter locking mechanism 30 selectively engages the detent pin engagement slot 24b to lock and unlock the automatic transmission cable lever 24 to/from the shift lever 20. In particular, the detent pin engagement slot 24b is configured and arranged to receive the second end 42b of the detent pin 42 such that the automatic transmission cable lever 24 and the shift lever 20 are locked together when the second end 42b of the detent pin 42 is received in the slot 24b of the automatic transmission cable lever 24. Thus, in any gear position other than the drive position D, the automatic transmission cable lever 24 and the shift lever 20 are locked together, because the first end 42a of the detent pin 42 engages the shift gate opening 60 in such a manner as to hold the detent pin 42 in a position in which the second end 42b of the detent pin 42 is located in the slot 24b of the automatic transmission cable lever 24. In the drive position D, the first end 42a of the detent pin 42 engages the shift gate opening 60 in such a manner as to hold the detent pin 42 in a position in which the second end 42b of the detent pin 42 is located above the slot 24b of the automatic transmission cable lever 24. Thus, in the drive position D, the shift lever 20 can be moved along the manual shift range without moving the automatic transmission cable lever 24.

The automatic transmission cable lever 24 is configured and arranged such that when the shift lever 20 is in the drive position D, the spring 44 urges the detent pin 42 upwardly out of the slot 24b of the automatic transmission cable lever 24.

The automatic transmission connection part 24c is connected to the shifter movement transmitting element 14 in a conventional manner. Thus, when the automatic transmission cable lever 24 is moved by the shift lever 20, the shifter movement transmitting element 14 is either pushed or pulled to operate the automatic transmission 12 in the automatic shift mode.

In operation, the shift lever 20 is selectively moved in a straight line path to select one of the park position P, the neutral position N, the reverse position R and the drive position D. When the shift lever 20 is located in the drive position D, the detent pin 42 is located in the slot 64 of the shift gate opening 60 so that the shift lever 20 can be moved back an forth through a predetermined range of movement. In the drive position D, the detent pin 42 is disengaged from the slot 24b of the automatic transmission cable lever 24. Thus, when the shift lever 20 is in the drive position D, the shift lever 20 can be moved forwardly or rearwardly along the straight line shift path without moving the automatic transmission cable lever 24. However, in the other positions P, R, and N, the detent pin 42 engages the shift gate opening 60 to hold the second end 42b of the detent pin 42 in the engaged position with the slot 24b of the automatic transmission cable lever 24 against the urging force of the spring 44.

As seen in FIGS. 6 and 7, when the shift lever 20 is in the drive position D, the shift lever 20 can be moved forwardly to the manual up-shift position M+ to manually upshift the automatic transmission 12 or moved rearwardly to the manual down-shift position M− to manually downshift the automatic transmission 12. In particular, if the shift lever 20 can be moved forwardly to the manual up-shift position M+ to manually upshift the automatic transmission 12, then the detent spring 68 rides up the up-shift switch ramp surface 74a and the first end 42a of the detent pin contacts the manual up-shift switch 26. Upon releasing the shift lever 20 in the manual up-shift position M+, the shift lever 20 automatically returns to the center neutral drive location from the manual up-shift position M+ due the urging force of the detent spring 68 applying an urging force against the up-shift switch ramp surface 74a of the drive position notch 74. Accordingly, this urging force of the detent spring 68 on the detent plate 66 causes the shift lever 20 to automatically move back to the center location of the drive position D. In this way, the driver can easily upshift the automatic transmission 12 by merely moving the shift lever 20 forwardly along the single straight line shift path of the shift lever 20. If the shift lever 20 can be moved rearwardly to the manual down-shift position M− to manually downshift the automatic transmission 12, then the detent spring 68 rides up the down-shift switch ramp surface 74b and the first end 42a of the detent pin contacts the manual down-shift switch 28. Upon releasing the shift lever 20 in the manual down-shift position M−, the shift lever 20 automatically returns to the center neutral drive location from the manual down-shift position M− due the urging force of the detent spring 68 applying an urging force against the down-shift switch ramp surface 74b of the drive position notch 74. Accordingly, this urging force of the detent spring 68 on the detent plate 66 causes the shift lever 20 to automatically move back to the center location of the drive position D. In this way, the driver can easily downshift the automatic transmission 12 by merely moving the shift lever 20 forwardly along the single straight line shift path of the shift lever 20.

As used herein, the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention.

Moreover, terms that are expressed as “means-plus function” in the claims should include any structure that can be utilized to carry out the function of that part of the present invention. The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. An inline automatic/manual shifter comprising:
a shift lever configured and arranged to selectively move in a straight line path to select one of a park position, a neutral position, a reverse position and a drive position;
a manual up-shift switch configured and arranged to be actuated by the shift lever while in the drive position to cause an upshift of the automatic transmission;
a manual down-shift switch configured and arranged to be actuated by the shift lever while in the drive position to cause a downshift of the automatic transmission;
a manual shift selector configured and arranged to select a manual shift mode activating the manual up-shift switch and the manual down-shift switch; and
a shift position retaining mechanism including a detent spring fixed to move with the shift lever and a shift position retaining element with a park position notch, a neutral position notch, a reverse position notch and a drive position notch,
the detent spring being configured and arranged to selectively engage the notches of the shift position retaining element to selectively retain the shift lever in one of the park position, the neutral position, the reverse position and the drive position,
the drive position notch being configured and arranged to form an up-shift switch ramp surface and a down-shift switch ramp surface with a center neutral drive location located between the up-shift and down-shift switch ramp surfaces,
the up-shift and down-shift switch ramp surfaces being configured and arranged such that the detent spring applies an urging force on the drive position notch to bias the detent spring to the center neutral drive location,
the up-shift and down-shift switch ramp surfaces being further configured and arranged such that the manual up-shift switch is operated when the detent spring is moved along the up-shift switch ramp surface and the manual down-shift switch is operated when the detent spring is moved along the down-shift switch ramp surface.

2. The inline automatic/manual shifter according to claim 1, wherein
the shift lever includes a movable detent pin arranged to selectively engage a stationary shift plate to prevent the shift lever from shifting from the drive position to one of the park position, the neutral position, and the reverse position while the detent pin remains engaged with the shift plate and the shift lever is located in the drive position.

3. The inline automatic/manual shifter according to claim 2, wherein
the detent pin is configured and arranged to selectively actuate the manual up-shift switch and the manual down-shift switch upon movement of the shift lever while the shift lever is located in the drive position.

4. The inline automatic/manual shifter according to claim 3, further comprising
an automatic transmission shift plate configured and arranged to be selectively engaged and disengaged by the detent pin such that the shift lever moves with the automatic transmission shift plate when the detent pin is engaged with the automatic transmission shift plate and the shift lever moves independently of the automatic transmission shift plate when the detent pin is disengaged with the automatic transmission shift plate.

5. The inline automatic/manual shifter according to claim 4, wherein
the automatic transmission shift plate is pivotally mounted about a pivot axis.

6. The inline automatic/manual shifter according to claim 5, wherein
the shift lever is pivotally mounted about the pivot axis of the shift plate.

7. The inline automatic/manual shifter according to claim 2, further comprising
an automatic transmission shift plate configured and arranged to be selectively engaged and disengaged by the detent pin such that the shift lever moves with the automatic transmission shift plate when the detent pin is engaged with the automatic transmission shift plate and the shift lever moves independently of the automatic transmission shift plate when the detent pin is disengaged with the automatic transmission shift plate.

8. The inline automatic/manual shifter according to claim 2, wherein
the shift lever includes an automatic shift selector located on an upper portion of the shift lever with the automatic shift selector being operatively coupled to the detent pin.

9. The inline automatic/manual shifter according to claim 1, wherein
the manual shift selector is located on an upper portion of the shift lever.

10. The inline automatic/manual shifter according to claim 1, wherein
the shift lever includes an automatic shift selector being operatively coupled move to a movable detent pin that engages a stationary shift plate to limit movement of the shift lever.

11. The inline automatic/manual shifter according to claim 1, wherein
the shift lever includes a movably detent pin that is arranged to selectively engage and disengage an automatic transmission shift plate while the shift lever is in the drive position such that the shift lever moves with the automatic transmission shift plate when the detent pin is engaged with the automatic transmission shift plate and the shift lever moves independently of the automatic transmission shift plate when the detent pin is disengaged with the automatic transmission shift plate.

12. The inline automatic/manual shifter according to claim 11, wherein
the detent pin is configured and arranged to selectively actuate the manual up-shift switch and the manual down-shift switch upon movement of the shift lever while the shift lever is located in the drive position.

13. The inline automatic/manual shifter according to claim 12, wherein
the automatic transmission shift plate and the shift lever are pivotally mounted about a pivot axis.

14. An inline automatic/manual shifter comprising:
a shift lever configured and arranged to selectively move in a straight line path to select one of a park position, a neutral position, a reverse position and a drive position;
a manual up-shift switch configured and arranged to be actuated by the shift lever while in the drive position to cause an upshift of the automatic transmission;
a manual down-shift switch configured and arranged to be actuated by the shift lever while in the drive position to cause a downshift of the automatic transmission;
a manual shift selector configured and arranged to select a manual shift mode activating the manual up-shift switch and manual down-shift switch; and
a shift position retaining mechanism configured and arranged to selectively retain the shift lever in one of the park position, the neutral position, the reverse position and the drive position;
a shift release device coupled to the shift lever to selectively lock the shift lever in the drive position and release the shift lever for movement along the straight line path, the shift release device including a detent pin that selectively engages a shift gate; and
an automatic transmission shift plate configured and arranged to be selectively engaged and disengaged by the detent pin such that the shift lever moves with the automatic transmission shift plate when the detent pin is engaged with the automatic transmission shift plate and the shift lever moves independently of the automatic transmission shift plate when the detent pin is disengaged with the automatic transmission shift plate.

15. The inline automatic/manual shifter according to claim 14, wherein
the automatic transmission shift plate and the shift lever are pivotally mounted about a pivot axis.

16. The inline automatic/manual shifter according to claim 14, wherein
the detent pin is configured and arranged to selectively actuate the manual up-shift switch and the manual down-shift switch upon movement of the shift lever while the shift lever is located in the drive position.

17. The inline automatic/manual shifter according to claim 14, wherein
the shift lever includes an automatic shift selector located on an upper portion of the shift lever with the automatic shift selector being operatively coupled move to the detent pin.

18. The inline automatic/manual shifter according to claim 14, wherein
the manual shift selector is located on an upper portion of the shift lever.

19. An inline automatic/manual shifter comprising:
hand operating means for selectively moving in a straight line path to select one of a park position, a neutral position, a reverse position and a drive position of an automatic transmission;
manual shifting means for manually shifting gears of the automatic transmission in response to movement of the hand operating means in the straight line path while the hand operating means is in the drive position; and
shift position retaining means for selectively retaining the hand operating means in one of the park position, the neutral position, the reverse position and the drive position while allowing a manual shift movement of the hand operating means along the straight line path from a central neutral location of the drive position to a manual shift location of drive position while the hand operating means is in the drive position,
the shift position retaining means being configured to apply an urging force to bias the hand operating means to the center neutral drive location of the drive position when the hand operating means is moved to the manual shift location of the drive position. on the drive position notch to bias the detent spring to the center neutral drive location

20. An inline automatic/manual shifter comprising:
hand operating means for selectively moving in a straight line path to select one of a park position, a neutral position, a reverse position and a drive position of an automatic transmission;
manual shifting means for manually shifting gears of the automatic transmission in response to movement of the hand operating means in the straight line path while the hand operating means is in the drive position; and
manual shift selecting means for selecting a manual shift mode that activates the manual shifting means; and
shift position retaining means for selectively retaining the hand operating means in one of the park position, the neutral position, the reverse position and the drive position while allowing a manual shift movement of the hand operating means along the straight line path from a central neutral location of the drive position to a manual shift location of drive position while the hand operating means is in the drive position,
manually operated shift release means for selectively locking the shift lever to in the drive position and release the shift lever for movement along the straight line path, the shift release means including detent means for selectively engaging a shift gate; and
automatic transmission shift means for selecting an automatic transmission position in response to movement of the hand operating means in the straight line path,
the automatic transmission shift means being configured and arranged to be selectively coupled to the hand operating means by the detent means of the manually operated shift release means such that the hand operating means moves with the automatic transmission shift means when the shift release means is engaged with the automatic transmission shift means and the hand operating means moves independently of the automatic transmission shift means when the shift release means is disengaged with the automatic transmission shift means.
